(19) United States
(12) Patent Application Publication
(10) Pub. No.: US 2007/0121246 A1
(43) Pub. Date: May 31, 2007

(54) THIN-FILM MAGNETIC HEAD FOR PERPENDICULAR RECORDING AND METHOD OF MANUFACTURING THE SAME

(75) Inventor: Kiyoshi Kobayashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/564,747

(22) Filed: Nov. 29, 2006

(30) Foreign Application Priority Data
Nov. 30, 2005 (JP) 2005-345752

(51) Int. Cl. G11B 5/127

(52) U.S. Cl. 360/125; 360/126

(57) ABSTRACT

A thin-film magnetic head and method of manufacturing the same are provided. The thin-film magnetic head includes a reading head that includes a reading element. A writing head is formed above the reading head. The writing head includes a first magnetic part and a second magnetic part that are connected with each other with a gap therebetween at a predetermined distance in a height direction side. A solenoidal coil layer that is formed by connecting ends of a first coil layer. The first magnetic part is formed on a first coil insulating layer and electrically connected with a conductive layer.

This application claims the benefit of Japanese Patent Application No. 2005-345752 filed Nov. 30, 2005, which is hereby incorporated by reference.

### BACKGROUND

1. Field

The present embodiments relate to a thin-film magnetic head and a method of manufacturing the thin-film magnetic head.

2. Related Art

A perpendicular recording magnetic head applies perpendicular magnetic field to a recording medium and perpendicularly magnetizes the head of the recording medium is known in the related arts (see JP-A-5-174332, JP-A-2001-101627, JP-A-2003-6819).

In conventional perpendicular recording magnetic heads, for example, according to a solenoidal type thin-film magnetic head, a perpendicular recording magnetic head is formed on a reading head. A reading head includes a reading element, a first coil layer, a main pole for recording, a second coil layer, and a recording head that has a return yoke formed in this order on the trailing end of a slider formed of a non-magnetic material. The main pole and the return yoke layer are connected at the end in a height direction and the first and second coils are connected such that they form a solenoidal coil wound around the main pole.

Conventionally, when a shield layer of a reading head and the main pole of a recording head and a return yoke layer have different potential process damage appears in a process of manufacturing a magnetic head. An exemplary process can be a waf process, or SLD/HGA process. Exemplary process damage can be corrosion or etching.

In the related art, in order to maintain a reading head and a main pole and a return yoke layer with the same potential, various types of configurations have been proposed, such as a configuration in which a conductive layer that contacts with a return yoke layer is provided and exposed to a medium-contacting surface (see JP-A-5-174332), or a configuration in which a non-magnetic metal layer is provided on an upper shield layer of a reading head and comes in contact with a main pole (see JP-A-2003-6819). However, according to the above configurations, new elements and processes for providing new layers should be added, thus additional layers and processes are required.

### SUMMARY

The present embodiments may obviate one or more of the drawbacks inherent in the related art. For example, in one embodiment, a thin-film magnetic head maintains a reading head and a recording head in the same potential and has a simple configuration.

In one embodiment, a thin-film magnetic includes a reading head that includes a reading element and a writing head that is formed above the reading head. The writing head includes a first magnetic part and a second magnetic part that are connected with each other with a gap therebetween at a predetermined distance in a height direction side, which is higher than a surface that faces a recording medium and a solenoidal coil layer that is formed by connecting ends of a first coil layer formed between the first magnetic part and the reading head and a second coil layer formed between the first and second magnetic parts in a track width direction and by winding the first and second coil layers around the first magnetic part.

In this embodiment, a coil insulating layer is formed on a shield layer of the reading head. A connecting hole that exposes a part of the shield layer is formed at a predetermined position of the coil insulating layer beyond the region for forming the first coil layer in the height direction. The first coil layer is formed on the coil insulating layer. A conductive layer made of the same non-magnetic material as the first coil layer is formed on the shield layer that serves as a bottom of the connecting hole. A first coil insulating layer is formed over the first coil layer and the conductive layer, while exposing the upper surface of the conductive layer. The first magnetic part is formed on the first coil insulating layer and electrically connected with the conductive layer.

In one embodiment, a thin-film magnetic head includes a reading head that includes a reading element and a writing head formed above the reading head. The writing head includes a first magnetic part and a second magnetic part that are connected with each other with a gap therebetween at a predetermined distance from a recording medium-facing surface in the height direction and a solenoidal coil layer that is formed by connecting ends of a first coil layer formed between the first magnetic part and the reading head and a second coil layer formed between the first and second magnetic parts in a track width direction and winding the first and second coil layers around the first magnetic part.

According to another embodiment, a method of manufacturing the thin-film magnetic head includes forming a coil insulating layer on a shield layer of the reading head; forming a connecting hole for exposing a part of the shield layer at a predetermined region of the coil insulating layer beyond the region for forming the first coil layer in the height direction; simultaneously forming the first coil layer on the coil insulating layer, and a conductive layer made of the same non-magnetic material as the first coil layer on the shield layer that serves as a bottom of the connecting hole; forming a first coil insulating layer over the first coil layer and the conductive layer, while exposing the upper surface of the conductive layer; and forming the first magnetic part on the first coil insulating layer so that the first magnetic part is electrically connected with the conductive layer.

In another embodiment, a contact layer may be simultaneously formed on the upper surfaces of both ends of the first coil layer in the track width direction and on the upper surface of the conductive layer, after the first coil layer and a conductive layer are simultaneously formed on the coil insulating layer and on the shield layer that serves as a bottom of the connecting hole, respectively.

In one embodiment, because shield layer of a reading head and a magnetic pole of a writing head are electrically connected through a conductive layer, the reading and writing heads have the same potential. In this embodiment, for example, corrosion or etching, does not appear in the manufacturing process.

In another embodiment, a conductive part can be simultaneously formed in a process for manufacturing a first coil layer. In this embodiment, the required process does not increase and productivity is not deteriorated. The first coil layer and the conductive layer are simultaneously formed of the same non-magnetic material, so that no additional material is needed.

### BRIEF DESCRIPTION OF THE DRAWINGS

FIG. 1 is a schematic vertical cross-sectional view of one embodiment of a perpendicular recording magnetic head;

FIG. 2 is a vertical cross-sectional view of one embodiment of a step of manufacturing process of the perpendicular recording magnetic head;

FIG. 3 is a vertical cross-sectional view of one embodiment of the manufacturing process of the perpendicular recording magnetic head;

FIG. 4a is a vertical cross-sectional view and 4b is a front view seen from a surface that faces a recording medium showing the next step of one embodiment of the perpendicular recording magnetic head;

FIG. 5a is a vertical cross-sectional view and 5b is a front view seen from the surface that faces the recording medium of one embodiment of the perpendicular recording magnetic head;

FIG. 6a is a vertical cross-sectional view and 6b is a front view seen from the recording medium-facing surface that shows of one embodiment of the perpendicular recording magnetic head; and

FIG. 7a is a vertical cross-sectional view and 7b is a front view seen from the recording medium-facing surface that shows of one embodiment of the perpendicular recording magnetic head.

### DETAILED DESCRIPTION

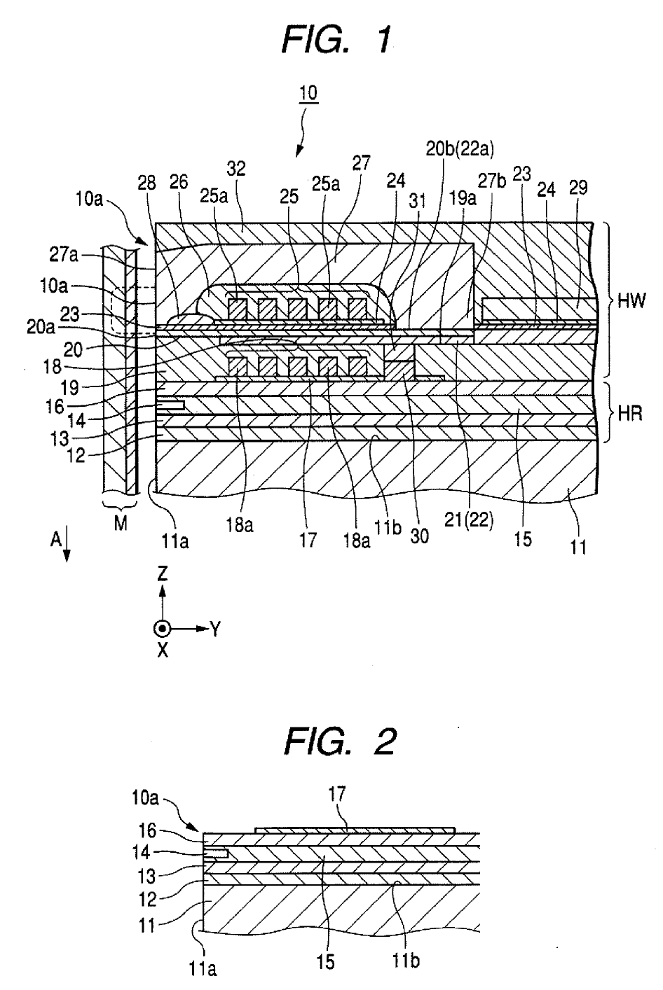

FIG. 1 is a schematic vertical cross-sectional view that shows a perpendicular recording magnetic head according to one embodiment. A perpendicular recording magnetic head 10, called a perpendicular magnetic head, applies a perpendicular magnetic field to a recording medium M by using a writing head HW that faces the recording medium M and perpendicularly magnetizes the hard film of the recording medium M. The writing head HW is formed on a reading head HR.

The perpendicular recording magnetic head 10 has a slider 11 formed of a non-magnetic material, for example, Al₂O₃, Tic, or the like. A recording medium-facing surface 11a of the slider 11 faces the recording medium M. As the recording medium M rotates, the slider 11 rises from the surface of the recording medium M due to the air flow on the surface and is held at a predetermined distance from the recording medium M.

Referring to FIG. 1, the X-axis is perpendicular to the figure, the Y-axis is perpendicular to a direction of arrow A and parallel with the figure, and the Z-axis is parallel and opposite to the direction of arrow A. The Y-axis direction is the height direction.

Referring to FIG. 1, in the perpendicular magnetic recording head 10, each component is formed in the Z-axis direction (opposite to the arrow A) on the trailing end 11b of the slider 11. A non-magnetic insulating layer 12 of an inorganic material, for example, Al₂O₃, SiO₂, or the like, is formed on the trailing end 1b of the slider 11 and the reading head HR is formed on the non-magnetic insulating layer 12. The reading head HR has a lower shield layer 13, an upper shield layer 16, and a reading element 14 embedded in a non-magnetic insulating layer (gap insulating layer) between the lower and upper shield layers 13 and 16. The reading element 14 is a magnetic reluctance element, for example, AMR, GMR, TMR, or the like. The writing head HW for perpendicular recording is formed on the upper shield layer 16 of the reading head HR.

A first coil layer 18 that has a plurality of conductive parts 18a formed of a conductive material is formed on the upper shield layer 16 by a coil insulating base layer 17. Each conductive part 18a of the first coil layer 18 is a single layer of one or more of non-magnetic materials selected from, for example, Au, Ag, Pt, Cu, Cr, Al, Ti, Nip, Mo, Pd, Rh, or a stacked layer of non-magnetic materials.

A conductive layer 30 is simultaneously formed of the same material as with the first coil layer 18 in a connecting hole 17 that is formed at a predetermined position in the height direction from the coil insulating base layer 17 on the upper shield layer 16. A contact layer 31 is formed on the conductive layer 30, for example, by nickel plating.

A first coil insulating layer 19 of an inorganic insulating material, for example, Al₂O₃, is formed over the first coil layer 18, the conductive layer 30, and the contact layer 31. The first coil insulating layer 19 covers the first coil layer 18 and the upper surface 19a is planarized such that the upper surface of the contact layer 31 is exposed. A yoke 21, a first magnetic part, is formed on the upper surface 19a of the first coil insulating layer 19 and extends from a position slightly closer to the recording medium-facing surface 10a than the first coil layer 18 in the height direction, and a main pole 20 is formed on the upper surface of the yoke 21.

The main pole 20 is formed such that the width in the track width direction of the end exposed to the recording medium-facing surface 10a is the track width. The main pole 20 is tapered, but widening in the track width direction along the yoke 21 from the recording medium-facing surface 10a in the height (depth) direction. The main pole 20 and the yoke 21 are formed of a ferromagnetic material with high saturation magnetic flux density, for example, by plating. In the main pole 20, a rectangular portion extending from the wide portion of the tapered portion is stacked on the yoke 21. The main pole 20 and the yoke 21 form a first magnetic part.

The yoke 21 extends to the upper surface of the contact layer 31 in the height direction, of which the lower surface is connected with the upper surface of the contact layer 31. The yoke 21 and the upper shield layer 16 are electrically connected with the same potential through the contact layer 31 and the conductive layer 30.

An insulating material layer 22 surrounding the main pole 20 and the yoke 21 is provided on the upper surface 19a of the first coil insulating layer 19. The upper surface 22a of the insulating material layer 22 forms the same surface as the upper surface 20b of the main pole 20. The insulating material layer 22 may be formed of any one or more of, for example, alumina (Al₂O₃), SiO₂, Al—Si—O.

A gap layer 23 formed of an inorganic material, such as alumina or SiO₂, on the main pole 20, the yoke 21, and the insulating material layer 22.

A second coil layer 25 is formed on the gap layer 23 through the coil insulating base layer 23. The second coil layer 25 is the same as the first coil layer 18 and includes a plurality of conductive parts 25a formed of a conductive non-magnetic metal. The second coil layer 25 is formed of one or more of non-magnetic metal selected from, for example, Au, Ag, Pt, Cu, Cr, Al, Ti, NiP, Mo, Pd, Rh, or may be formed by stacking non-magnetic metals. The insulating material layer 22, gap layer 23, and coil insulating base layer 24 are insulating layers.

In the conductive parts 18a and 25a of the first and second coil layers 18 and 25, the ends in each track width direction (the X-axis direction) are electrically connected to form a solenoidal coil (not shown), so that a solenoidal coil is formed by winding the first and second coil layers 18 and 25 around the main pole 20 and the yoke 21. As for the present embodiment, the width of the first coil layer 18 in the height direction (the Y-axis direction) is the same size as that of the second coil layer 25 in the height direction (the Y-axis direction).

In one embodiment, a second coil insulating layer 26 formed of an inorganic insulating material, for example, Al₂O₃, covers the second coil layer 25. A return yoke 27, a second magnetic part, is formed of a ferromagnetic material, such as permalloy, or the like, throughout the second coil insulating layer 26 and the gap layer 23. The surface of the return yoke 27 that faces the recording medium is exposed to the recording medium-facing surface 10a. The return yoke 27 is connected with a part of the main pole 20 that is not covered with the second coil insulating layer 26 through a conductive portion 27b located far from the recording medium-facing surface 10a. According to the above configuration, a magnetic path from the main pole 20 through the return yoke 27 is formed.

A throat height determining layer 28 is formed of an inorganic or organic material at a predetermined distance from the recording medium-facing surface 10a in the height direction on the gap layer 23. The throat height (gap depth) distance from the perpendicular recording magnetic head 10 is defined as from the recording medium-facing surface 10a to the front end of the throat height determining layer 28.

On the coil insulating base layer 24, a lead layer 29 that extends from the second coil layer 25 is formed at a predetermined position from the conductive portion 27b of the return yoke 27 in the height direction (the Y-axis). The return yoke 27 and the lead layer 29 are covered by a protecting layer 32 formed of, for example, an inorganic non-magnetic insulating material.

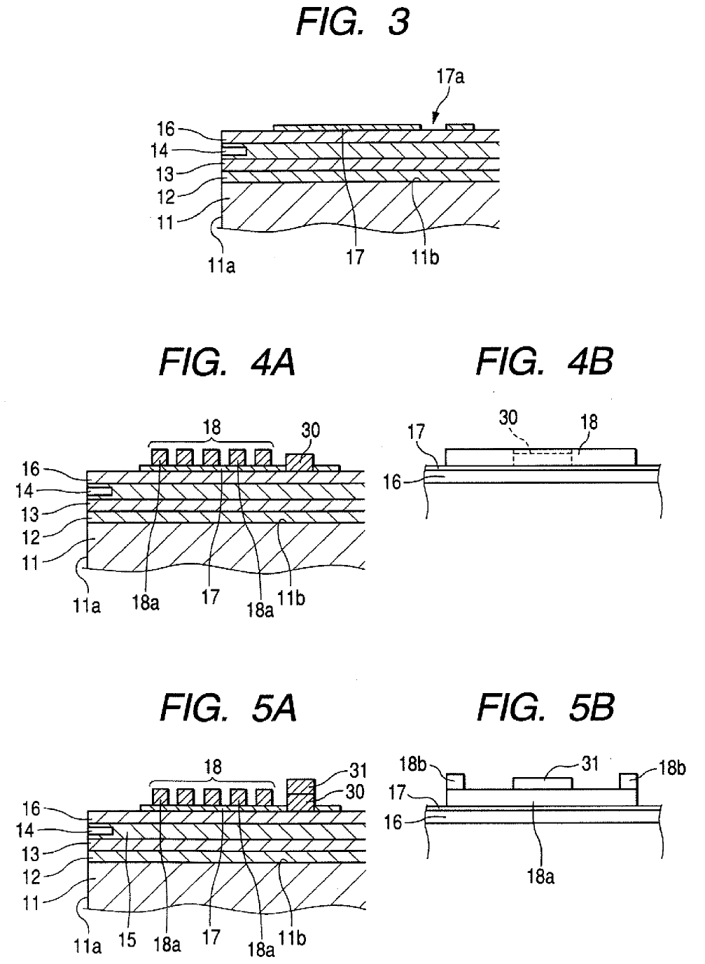

In a method of manufacturing the perpendicular recording magnetic head 10, a process of manufacturing the conductive layer 30 and the contact layer 31 is described below with reference to FIGS. 2 to 7. FIGS. 2 and 3 are vertical cross-sectional views for different processes. As for FIGS. 4 to 7, (a) shows a vertical cross-sectional view in each different process and (b) shows a front view that shows a portion above the upper shield layer 16 of the perpendicular recording magnetic head 10 in each different process.

FIG. 2 is a cross-sectional view that shows the upper shield layer 16 being formed. The coil insulating base layer 17 is formed on the upper shield layer 16 by spattering (FIG. 1) such that it is wider than the region for the first coil layer 18.

In one embodiment, each conductive part 18a of the first coil layer 18 and the conductive layer 30 are formed. The conductive part 18a and the conductive layer 30, for example, are formed by a process of forming a plated base layer on the upper shield layer 16 under the region for the conductive part 18a and the connecting hole 17 for the conductive layer 30 and then forming non-magnetic material, for example, Cu, on the plated base layer with a predetermined thickness by electric plating (FIGS. 4a and 4b).

Following the above process, the contact layers 18b and 31 are simultaneously formed with a predetermined thickness on the upper surface of both end of the conductive part 18a and the conductive layer 30 (FIGS. 5a and 5b). The thicknesses of the first coil layer 18 and the conductive layer 30, and the upper surface of the contact layer 1b are as high as the thickness of the coil insulating base layer 17 larger than the upper surface of the contact layer 31 (FIG. 5b).

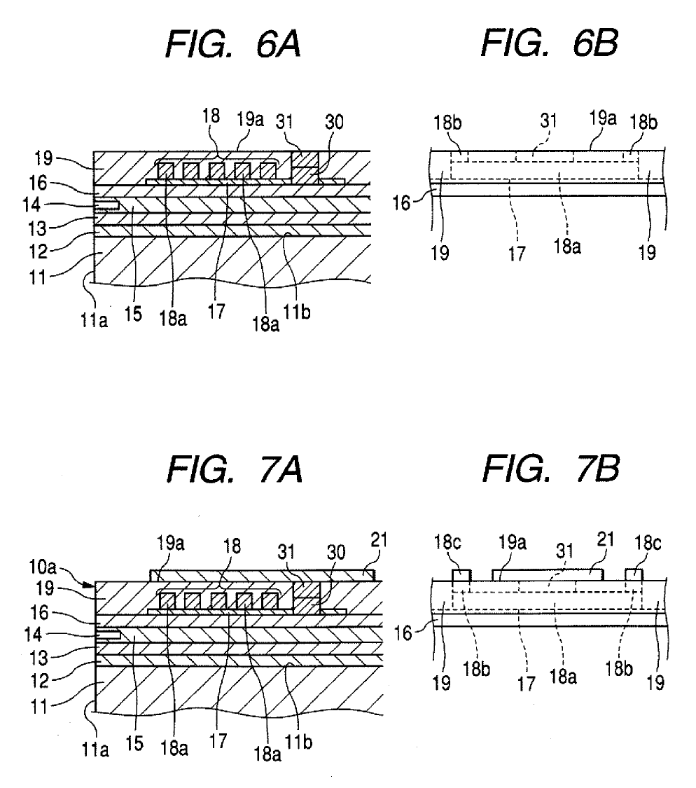

Subsequently, the first coil insulating layer 19 is formed by covering the first coil layer 18, contact layer 18b, conductive layer 30 and contact layer 31 with an inorganic insulating material such as Al₂O₃ (FIGS. 6a and 6b). After the covering, CMP process is applied to the first coil insulating layer 19 to planarize the upper surface. The upper surfaces of the contact layers 18b and 31 and the first coil insulating layer 19 are planarized such that they are level with each other through the CMP process (FIG. 6b).

On the upper surface 19a of the first coil insulating layer 19, the yoke 21 is formed of a ferromagnetic material that has high saturation magnetic flux density, for example, Ni—Fe, between the two rows of contact layers 18b spaced with a predetermined distance (FIGS. 7a and 7b). The yoke 21 is formed from a predetermined position, which is closer to the recording medium-facing surface 10a than the first coil layer 18 in the height direction to a predetermined position such that it covers the upper surface of the contact layer 31, more than the track width.

The upper shield layer 16 is electrically connected with the yoke 21 through the conductive layer 30 and the contact layer 31 by connecting the yoke 21 and the contact layer 31, and both have the same potential.

The main pole 20 is formed on the upper surface of the yoke 21 and the other components are formed, but it is not described for avoiding repetition because they are formed through conventional processes. The main pole 20 may be connected with the contact layer 31 by changing places of the yoke 21 with the main pole 20 or removing the yoke 21. The return yoke layer 27 (conductive part 27b) and the contact layer 31 may be connected.

The contact layer 28c may be stacked on the upper surface of the contact layer 18b while simultaneously forming the yoke 21 or the main pole 20 (FIG. 7b). The contact layer 18c is connected with the end in the width direction of the conductive part 25a of the second coil layer 25 and a solenoidal coil is formed around the main pole 20 and the yoke 21. In one embodiment, only the main pole 20 is included and not the yoke 21.

In one embodiment, in the process of manufacturing the first coil layer 18, the conductive layer 30 is formed of the ferromagnetic material as for the first coil layer 18 and the contact layer 31 is formed by nickel plating as the coil layer 18 in the process of manufacturing the contact layer 18b.

In one embodiment, the reading element 14 and the main pole 20 maintain connection with the same potential without the processes or material being increased. The reading element 14 and the main pole 20 are connected by a non-magnetic material, so that the return yoke layer 27 and the upper shield layer 16 are magnetically connected and other shield, in addition to the main pole 20, re-records recording signals onto a recording medium, thus the risk of loosing the signals is reduced.

Although the connecting hole is formed at the coil insulating base layer 17, the length in the height direction of the coil insulating base layer 17 may shortened and the conductive layer 30 may be formed on the upper shield layer 16 exposed at a predetermined position from the coil insulating base layer 17.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A thin-film magnetic head comprising:
a reading head that includes a reading element; and
a writing head that is formed above the reading head,
wherein the writing head includes a first magnetic part and a second magnetic part that are connected with each other with a gap therebetween at a predetermined distance in a height direction side, and a solenoidal coil layer that is formed by connecting ends of a first coil layer,
a coil insulating layer is formed on a shield layer of the reading head,
a connecting hole for exposing a part of the shield layer is formed at a predetermined position of the coil insulating layer beyond the region for forming the first coil layer in the height direction,
the first coil layer is formed on the coil insulating layer,
a conductive layer made of the same non-magnetic material as the first coil layer is formed on the shield layer,
a first coil insulating layer is formed over the first coil layer and the conductive layer, while exposing the upper surface of the conductive layer, and
the first magnetic part is formed on the first coil insulating layer and electrically connected with the conductive layer.

2. The thin-film magnetic head according to claim 1, wherein the writing head is formed at a predetermined distance higher than a surface that faces a recording medium.

3. The thin-film magnetic head according to claim 1, wherein the first coil layer is formed between the first magnetic part and the reading head and a second coil layer formed between the first and second magnetic parts in a track width direction and winding the first and second coil layers around the first magnetic part.

4. The thin-film magnetic head according to claim 1, wherein the conductive layer serves as a bottom of the connecting hole.

5. A method of manufacturing a thin-film magnetic head that includes a reading head including a reading element, and a writing head formed above the reading head, and the writing head including a first magnetic part and a second magnetic part that are connected with each other with a gap therebetween at a predetermined distance in a height direction side and a solenoidal coil layer that is formed by connecting ends of a first coil layer formed between the first magnetic part and the reading head and a second coil layer formed between the first and second magnetic parts in a track width direction and winding the first and second coil layers around the first magnetic part, the method comprising:
forming a coil insulating layer on a shield layer of the reading head;
forming a connecting hole for exposing a part of the shield layer at a predetermined region of the coil insulating layer beyond the region for forming the first coil layer in the height direction;
simultaneously forming the first coil layer on the coil insulating layer and a conductive layer made of the same non-magnetic material as the first coil layer on the shield layer that serves as a bottom of the connecting hole;
forming a first coil insulating layer over the first coil layer and the conductive layer, while exposing the upper surface of the conductive layer; and
forming the first magnetic part on the first coil insulating layer so that the first magnetic part is electrically connected with the conductive layer.

6. The method of manufacturing a thin-film magnetic head according to claim 2, further comprising:
simultaneously forming a contact layer on the upper surfaces of both ends of the first coil layer in the track width direction and on the upper surface of the conductive layer, after the simultaneous forming of the first coil layer on the coil insulating layer and a conductive layer on the shield layer that serves as a bottom of the connecting hole.

7. A method of manufacturing a thin-film magnetic head comprising:
forming a coil insulating layer on a shield layer of a reading head;
forming a connecting hole at a predetermined region of the coil insulating layer beyond the region for forming a first coil layer in the height direction;
forming the first coil layer on the coil insulating layer and a conductive layer made of the same non-magnetic material as the first coil layer on the shield layer;
forming a first coil insulating layer over the first coil layer and the conductive layer, while exposing the upper surface of the conductive layer; and
forming the first magnetic part on the first coil insulating layer so that the first magnetic part is electrically connected with the conductive layer.

8. The method of manufacturing a thin-film magnetic head according to claim 7, further comprising:
simultaneously forming a contact layer on the upper surfaces of both ends of the first coil layer in the track width direction and on the upper surface of the conductive layer, after the simultaneous forming of the first coil layer on the coil insulating layer and a conductive layer on the shield layer that serves as a bottom of the connecting hole.
